(19) United States
(12) Patent Application Publication
(10) Pub. No.: US 2013/0214771 A1
(43) Pub. Date: Aug. 22, 2013

(54) SYSTEMS AND METHODS FOR INSPECTING STRUCTURES INCLUDING PIPES AND REINFORCED CONCRETE

(71) Applicant: Radiation Monitoring Devices, Inc., (US)

(72) Inventors: Timothy C. Tiernan, Newton, MA (US); Mark Steinback, Newton, MA (US); Noa M. Rensing, West Newton, MA (US); Evan Weststrate, Newton, MA (US)

(73) Assignee: Radiation Monitoring Devices, Inc., Watertown, MA (US)

(21) Appl. No.: 13/750,591

(22) Filed: Jan. 25, 2013

Related U.S. Application Data
(60) Provisional application No. 61/590,620, filed on Jan. 25, 2012.

(51) Int. Cl. G01N 27/90

(52) U.S. Cl. CPC G01N 27/904
USPC 324/242

(57) ABSTRACT

Devices and methods for detecting defects in reinforced concrete using eddy current detection technology are disclosed. In one aspect, a method for detecting defects in reinforced concrete may include the steps of: providing a probe with a plurality of eddy current sensors disposed along a circumferential direction of the probe; inducing an eddy current in a reinforcing structure of the reinforced concrete with at least one of the plurality of eddy current sensors; and detecting a circumferential and longitudinal location of a defect in the reinforcing structure of the reinforced concrete with at least one of the plurality of eddy current sensors.

### RELATED APPLICATIONS

This application claims priority to U.S. Provisional Application No. 61/590,620, filed Jan. 25, 2012 which is incorporated herein by reference in its entirety.

### BACKGROUND

1. Field

The present application discloses various aspects relating to eddy current detection technology.

2. Related Art

There is over 11,000 km of reinforced concrete pipe in the United States alone. Replacement of this pipe costs approximately $2,000,000-$15,000,000 per km with an overall infrastructure value of approximately $40 billion. In addition, the current pipe infrastructure is old and aging. As a pipe ages the metal reinforcements within the concrete may develop defects affecting their safety. In general, materials may have defects (or flaws) in them, such as cracks, inclusions and corrosion. The defects may form for various reasons, including as a result of manufacturing, stresses and/or corrosion experienced by the material over its lifetime. A typical situation is shown in FIG. 3 depicting a reinforced concrete pipe 300, which includes a metal reinforcement 302 containing a defect 304. However, the metal reinforcement and associated defect are disposed within the concrete making direct non-destructive inspection impossible. Further complicating detection is that reinforced concrete pipe is often times buried rendering the various applicable manual inspection methods difficult at best.

One manner for detecting such defects in a conductive material (such as a metal or metal alloy) is to generate eddy currents within the material and detect the resulting magnetic fields. Eddy currents are generated in a conductive material in response to a suitable time varying magnetic field being applied to the conductive material. The time varying magnetic field gives rise to a force on the electrons in the conductive material, thus creating current, referred to as “eddy current.” The eddy currents themselves give rise to magnetic fields, referred to as induced magnetic fields, which oppose the incident magnetic field. The distributions of the eddy currents will be altered by cracks (or other defects) in the material, thus creating perturbations in the induced magnetic fields. The changes in the induced magnetic fields, which are detected with an eddy current sensor, give an indication of the presence of the cracks (or other defects) and their characteristics (e.g., location, size, shape, etc.). Generally, when applied to a uniform material, the magnetic field due to the coil as well as the magnetic fields arising from the eddy currents induced in a uniform material have a well characterized spatial distribution which is exactly axial at the center of the current loop and has field lines that surround the current distribution. The magnetic fields has both radial and axial components, and near the center the in plane component is very small. For a circular coil and a uniform material, the tangential component of both direct and induced magnetic fields is zero. In contrast, if there are cracks or other irregularities in the material which disrupt the eddy currents and perturb the magnetic field, the induced magnetic field may be modified and may have substantial in-plane components and possibly substantial tangential components. These in-plane components may be easier to detect than changes in the substantial axial magnetic field.

This effect may be especially pronounced if the position of the crack or flaw relative to the coil is such that the maximum eddy current density would pass through that point in the absence of the flaw, and if the characteristic depth of the eddy current distribution is comparable to or smaller than the extent of the crack or flaw in the depth direction.

Conventional coil-based eddy current sensors generally take one of two forms. A first type of conventional coil-based eddy current sensor uses a single coil (i.e., a combined drive/detection coil) to both carry the current that generates (or drives) the incident magnetic field applied to the conductive material under test and detect the magnetic field due to the eddy currents in the material under test. Monitoring this field allows the instrument to detect changes caused by cracks or other flaws. A second type of conventional coil-based eddy current sensor uses two distinct co-axial coils—one which carries the current that generates (or drives) the incident magnetic field applied to the conductive material under test and a second which detects the total magnetic field and can be monitored to detect changes due to cracks (or other defects) in the material under test.

FIG. 1 illustrates a conventional coil-based eddy current sensor of the first type. The probe 100 includes a single coil 102 through which an alternating current (AC) current is applied to generate a magnetic field incident upon a conductive material under test 104 when the probe is placed in proximity to the material under test. The incident magnetic field gives rise to eddy currents in the material under test 104 as shown which generate a magnetic flux which passes through the coil 102. A crack (or other type of defect) 106 in the material under test 104 disturbs the eddy currents 108 and therefore the magnetic flux. The disturbance in the magnetic flux thus indicates the presence of the crack (or other type of defect).

FIG. 2 illustrates a conventional coil-based eddy current sensor of the second type. As shown, the probe 200 includes two distinct but co-axial coils, a drive coil 202 to generate the eddy currents in the material under test by applying an incident magnetic field and a detection coil 204 (of one or more turns) to detect the magnetic flux resulting from the eddy current. Because the coils 202 and 204 are co-axial, the sensitive axis of the detection coil is parallel to the principal axis of the drive coil (i.e., the primary direction of the magnetic field generated by the drive coil).

It should be appreciated from FIGS. 1 and 2 that both of these types of conventional coil-based eddy current sensors use a detection coil that is sensitive to the magnetic field components oriented in the same direction as the magnetic fields created by the drive coil. These fields are generally oriented in the direction normal to the surface of the material under test.

In the case of a two coil eddy current sensor, however, the detection coil may alternately be arranged with its axis at an angle to the drive coil axis, so as to be more sensitive to in plane components of the magnetic field or specifically to the tangential direction or to in-plane components (either tangential or radial) at the center of the coil, or to reduce its sensitivity to the out-of-plane component of the magnetic field.

Some conventional eddy current sensors do not use a detection coil, and instead use a solid-state magnetic field detecting element. These include magneto-resistive sensors (such as anisotropic (AMR) or giant magnetoresistive sensors), Hall Effect sensors, and superconducting quantum interference devices (SQUIDS). In the case of magnetoresistive sensors, the resistance of the sensor varies depending on the magnetic field applied to the sensor. Thus, when an AMR sensor is placed in the presence of an eddy current, the magnetic fields generated by the eddy current may alter the resistance value of the AMR sensor. The alteration in the resistance value is used to detect the presence and strength of the eddy currents and thus of any defects in the material under test.

### SUMMARY

Eddy current sensors and related methods are disclosed.

In one embodiment, a method for detecting defects in reinforced concrete may include: providing a probe with a plurality of eddy current sensors disposed along a circumferential direction of the probe; inducing an eddy current in a reinforcing structure of the reinforced concrete with at least one of the plurality of eddy current sensors; and detecting a circumferential and longitudinal location of a defect in the reinforcing structure of the reinforced concrete with at least one of the plurality of eddy current sensors.

In another embodiment, a method for detecting defects in reinforced concrete may include: providing a flexible array of eddy current sensors disposed along a circumferential direction of the probe; inducing an eddy current in a reinforcing structure of the reinforced concrete with at least one of the plurality of eddy current sensors; and detecting a defect in the reinforcing structure of the reinforced concrete with at least one of the plurality of eddy current sensors.

In yet another embodiment, a method for detecting defects may include: providing a probe with a plurality of eddy current sensors disposed along a circumferential direction of the probe; inducing an eddy current in a material with at least one of the plurality of eddy current sensors; and detecting a circumferential and longitudinal location of a defect in the material.

In another embodiment, a method for detecting defects in a structure may include: providing a probe with at least one driver and a plurality of eddy current sensors disposed along at least a portion of the periphery of the probe; inducing an eddy current in the structure with the at least one driver; and detecting a defect in the structure with at least one of the plurality of eddy current sensors.

In yet another embodiment, a method for detecting defects in a structure may include: providing a probe with at least one driver and at least one eddy current sensor; and inducing an eddy current in the structure with the at least one driver at a frequency that substantially corresponds to an electrical resonate frequency of the structure.

In another embodiment, a method for detecting defects in a structure may include: providing a probe with at least one driver and at least one eddy current sensor, wherein the driver comprises at least one rotatable permanent magnetic; and rotating the at least one permanent magnet at a frequency to induce eddy currents in the structure.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF DRAWINGS

FIG. 1 illustrates a first type of conventional coil-based eddy current sensor having a combined drive/detection coil;

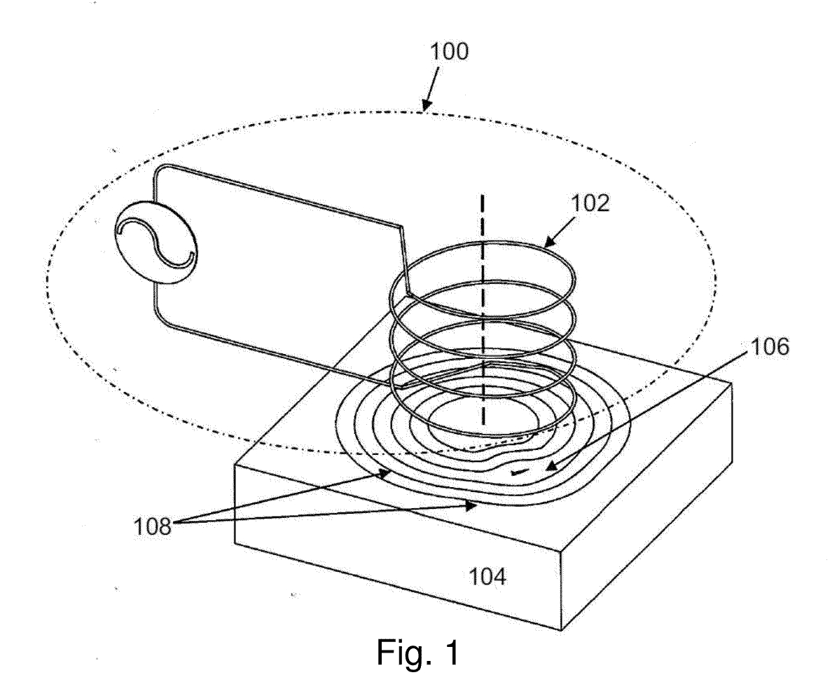

FIG. 2 illustrates a second type of conventional coil-based eddy current sensor having distinct, co-axial drive and detection coils;

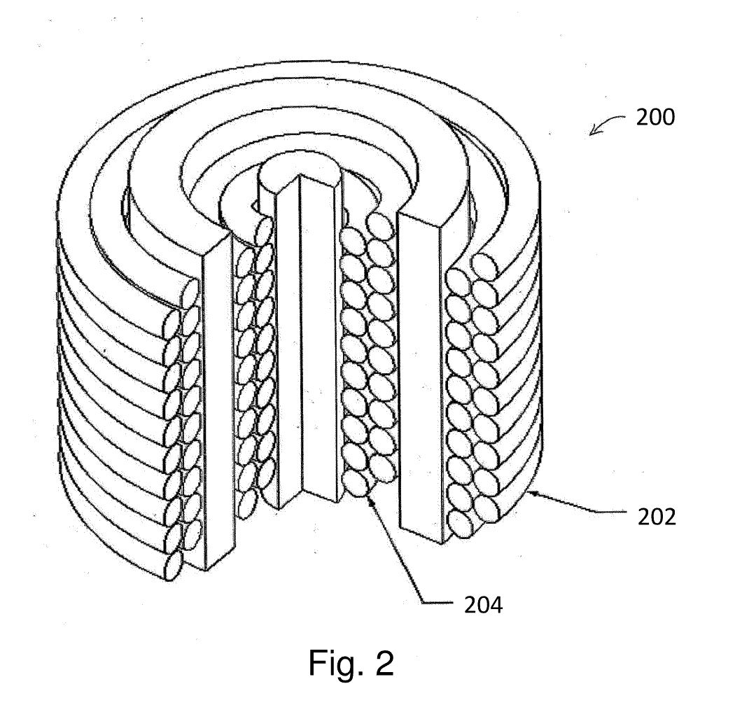

FIG. 3 illustrates a reinforced concrete pipe with a metal reinforcement containing a defect;

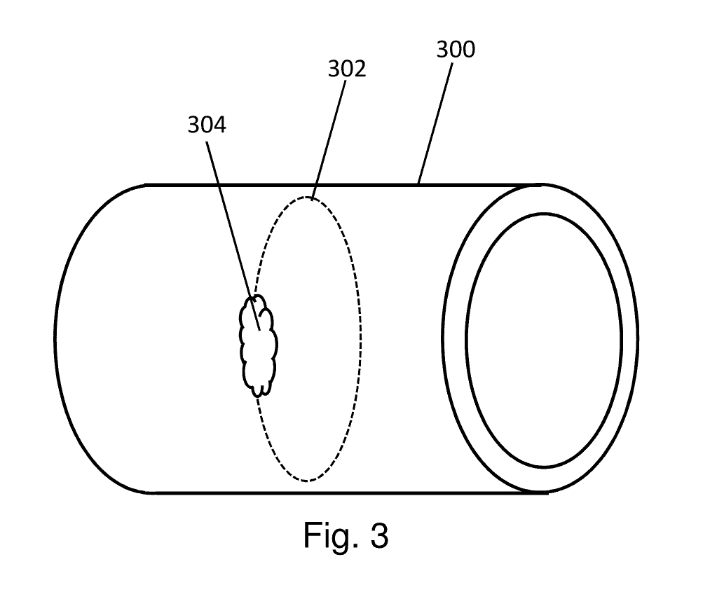

FIG. 4 illustrates an embodiment of a probe with a plurality of circumferentially arranged eddy current sensors scanning a reinforced concrete pipe;

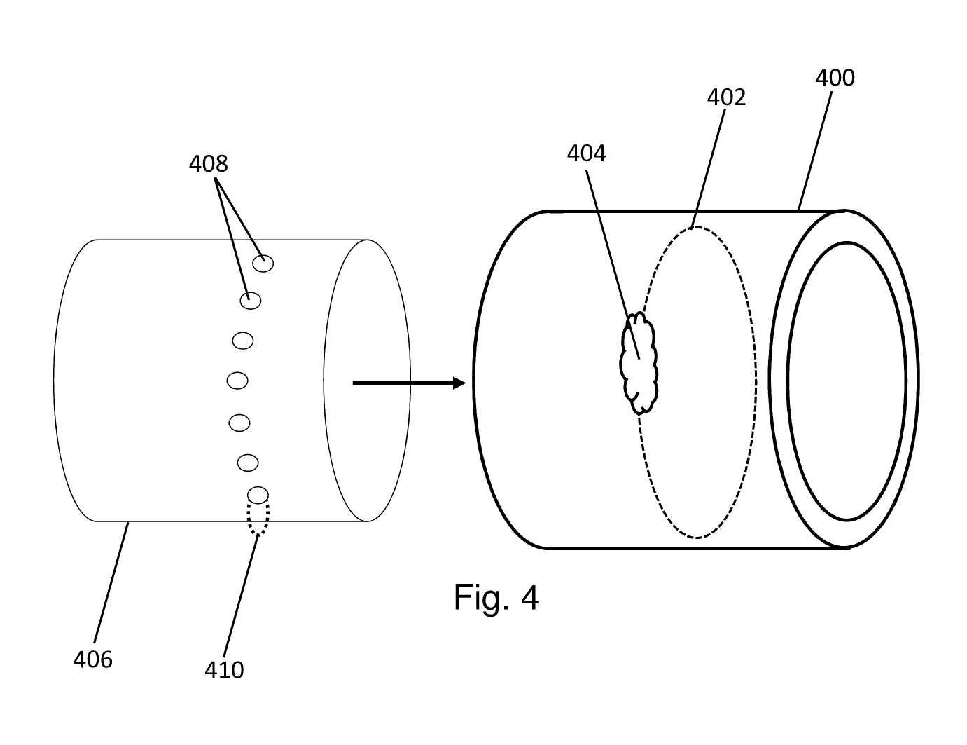

FIG. 5 illustrates an embodiment of a flexible array of eddy current sensors placed on a reinforced concrete pipe;

FIG. 6 is a graph that presents an exemplary sensor array signal of a sample containing a defect;

FIG. 7 schematically illustrates eddy currents in a pipe and the associated magnetic field direction;

FIG. 8 schematically illustrates the alignment of a magnetic coil to create the circumferential eddy currents depicted in FIG. 8;

FIG. 9 schematically illustrates one embodiment of a quadrupole field driver;

FIG. 10 schematically illustrates the orientation of the quadrupole field driver of FIG. 9 with respect to the pipe;

FIG. 11 schematically illustrates another embodiment of a quadrupole driver layout;

FIG. 12 schematically illustrates an embodiment including a rotating magnet and an associated array of sensors;

FIG. 13 schematically illustrates another embodiment including a rotating magnet and an associated array of sensors;

FIG. 14 schematically illustrates a pair of counter rotating magnets used to create a single oscillating magnetic dipole moment;

FIG. 15 schematically illustrates the internal construction of an embedded core of a pre-stressed concrete core pipe;

FIG. 16 depicts a simplified electrical model of a single winding, or section of winding, of the pre-stressed concrete core pipe;

FIG. 17 depicts a distributed electrical model of the pipe windings, with a break far away from the driver/detector;

FIG. 18 depicts a distributed electrical model of the pipe windings, with a break near the driver/detector;

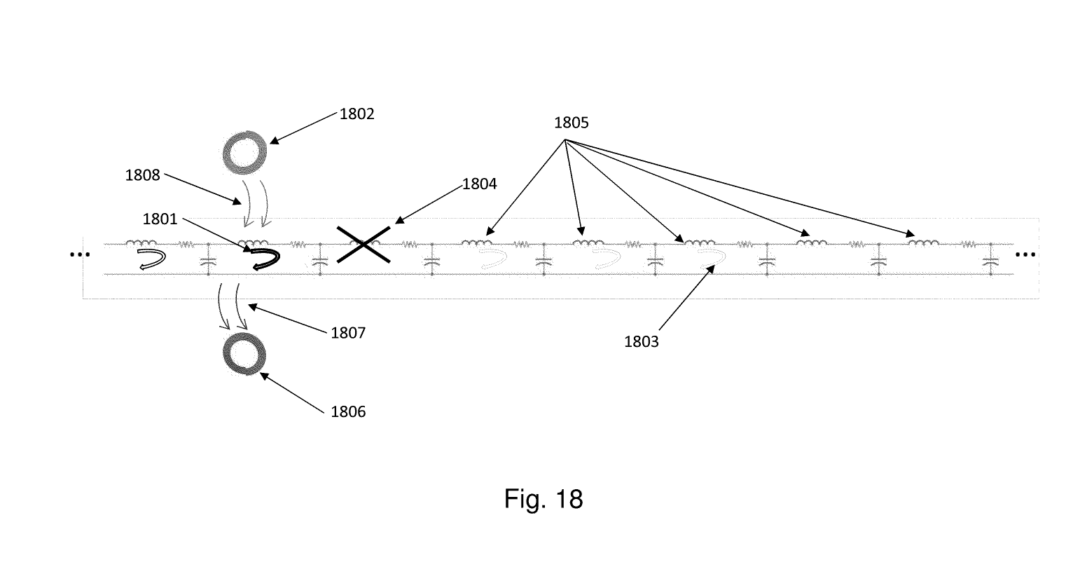

FIG. 19 depicts a schematic representation of a cross section of the pre-stressed concrete core pipe with a driver coil and detector fixed to the inside of the core; and

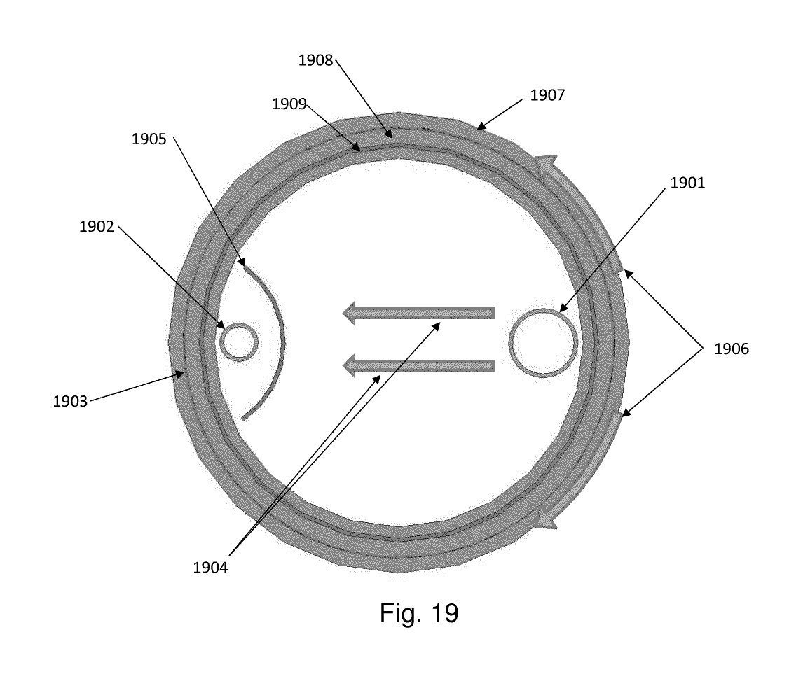

FIG. 20 is graph of detector signal as a function of driver coil frequency at constant power.

### DETAILED DESCRIPTION

In view of the above, the inventors have appreciated the need for systems and methods to non-destructively inspect reinforced concrete pipe. More specifically, the inventors have recognized the advantages of using a plurality of eddy current sensors disposed around at least a portion of the periphery of a probe for the purpose of detecting defects in the metal reinforcements disposed within a reinforced concrete pipe, or other appropriate structure. In another aspect, the inventors have recognized the advantages of a flexible array of eddy current sensors that may monitor a particular section of reinforced concrete pipe over a long period of time either in a location of a detected defect or in a location prone to defects.

While the embodiments discussed below are mainly directed at reinforced concrete pipes, the current disclosure is not limited in this fashion. Instead the disclosure generally teaches the use of a plurality of eddy current sensors incorporated into a probe to scan an object, or structure, for defects in a single pass or at the least in fewer passes than a conventional single sensor. The probes and sensors may be constructed and arranged to conform to the shape of the object or structure. For example, a pig used in the oil and gas industry for inspecting metallic pipelines may include a plurality of sensors disposed along the pig in a circumferential direction to scan the entire metal pipeline instead of metal reinforcements disposed within reinforced concrete pipes. Similarly, while the sensor arrays have been disclosed with regards to sensing metallic reinforcements within reinforced concrete pipes, the sensor arrays may also be used in any other number of other applications including detecting defects in monolithic materials, bridges, structures, metal pipelines, and any other appropriate application for which a nondestructive detection method is desirable.

The reinforcing metal within a reinforced concrete pipe is general constructed as a cage with longitudinal pieces extending along the longitudinal axis of the concrete pipe which are welded to circumferential pieces extending substantially orthogonal thereto. In some constructions the circumferential pieces may be helically wound around the longitudinal pieces. In other constructions there may be a plurality of circumferential pieces that extend substantially perpendicular to the longitudinal pieces. The longitudinal and circumferential pieces are generally supplied as single pieces dispensed from a reel or spool that are cut to the desired final length. For the purpose of clarity, the figures only depict a single circumferential piece. The reinforcing metal may be metal wire, metal rod, rebar, or any other appropriate material. The reinforcing metal may also be provided in straight sections or it may be bent, curved, or come in any desirable shape.

In one embodiment a probe 406 may be sized and shaped to fit within the interior of reinforced concrete pipe 400 for the purpose of detecting defects 404 in the metal reinforcements 402 contained within the concrete pipe. Defects in the metal reinforcements that may be detected include, for example, corrosion, fracture, thinning, and other defects and failure modes as would be appropriate for a given application. The probe may include a plurality of eddy current sensors 408 circumferentially arranged along a disk like section of the probe substantially aligned with a circumferential direction of the reinforced pipe. The eddy current sensors generate electromagnetic fields 410 to induce eddy currents in the metal reinforcements. Due to the arrangement of the sensors along the circumference of the probe, the probe may sense defects at different circumferential positions of the concrete pipe. In addition, since the eddy current sensors are aligned within a disk like section of the probe the longitudinal location of each sensor along the length of the pipe is known relative to the longitudinal location of the probe. Therefore, when a defect or metal reinforcement is detected its longitudinal location may be noted and logged. Consequently, the current system may be able to determine both the longitudinal and circumferential location of a defect with a relatively high degree of precision.

Depending on the particular application, the eddy current sensors may be arranged and constructed differently. In some instance it may be necessary adjust the eddy current sensors to sense defects in metal reinforcements of a different size or at different depths within different reinforced concrete pipes. Similarly, the probes may be spaced closer or farther apart in the circumferential direction depending on the area each probe is adapted to measure. For example, eddy current sensors which measure a larger area may be spaced further apart. Conversely eddy current sensors which measure a smaller area may be spaced closer together. In one preferred embodiment, the eddy current sensors may include an AMR sensor. However, the current disclosure is not limited to any particular type of driver or sensor.

As described above, there are multiple overlapping longitudinal and circumferential metal reinforcements present within a concrete pipe that may make interpreting where a defect is present difficult. Consequently, it may be desirable to correlate the sensed signals with particular pieces of reinforcement to determine if there is a defect present along the length of a particular reinforcement or whether a particular signal simply corresponds to a space between two adjacent unconnected pieces of reinforcement. This may be done in various ways as detailed below.

In one embodiment, the probe may simply monitor the signals from each of the eddy current sensors during testing and store the logged data in memory. The stored data from each eddy current sensor may be subsequently analyzed to determine where metal reinforcement has been detected. The presence of a metal reinforcement may be determined by comparing the observed signals to a calibration performed on a similarly sized reinforced pipe without defects. The data may then be further analyzed to identify individual continuous pieces of reinforcement. In another related embodiment, the probe may only log data when a metal reinforcement is detected at a particular probe which may help eliminate the need to identify the metal reinforcement as a separate analysis step. This may be accomplished by only logging signals above a threshold reference value as determined from the calibration noted above. The individual metal reinforcements may then be identified as noted above.

In another embodiment, it may be desirable to spin the probe within the concrete pipe so that a single eddy current sensor may log the signal corresponding to a helically wound circumferential reinforcing member. This may offer the benefit of avoiding a non-continuous signal corresponding to the circumferential member. Without wishing to be bound by theory, a continuous signal, as compared to a reconstructed signal from each of the eddy current sensors arranged around the circumference of the probe, may result in more accurate detection of defects in the circumferential member. To implement such a method the probe could be controlled to spin at a rate corresponding to the pitch of the helically wound circumferential pieces. In some instances, a controller within the probe may actively control the spin of the probe to match the position of a circumferential piece as it travels down a concrete pipe.

While the above method could result in a single continuous signal corresponding to the circumferential pieces, the signals of the longitudinal members would now be reconstructed from the signals of each of the eddy current sensors arranged around the circumference of the probe. Therefore, in some embodiments it may be desirable to combine scans of the longitudinal piece without spinning the probe and scans of the circumferential pieces while spinning the probe. To implement such a method it would be necessary to analyze the data corresponding to each and eliminate the unnecessary data from each data set. The two modified data sets corresponding to the continuous scans of the longitudinal and circumferential pieces could then be combined.

Regardless of which method is used to scan and identify the individual circumferential and longitudinal pieces of reinforcement, another analysis step may be performed to identify defects within each of the longitudinal and circumferential pieces. As discussed above, defects may be determined from variations in the detected signal. Therefore, variations in the detected signal along the continuous length of each identified metal reinforcement may indicate a defect within that particular piece of reinforcment. In some embodiments, defects may be determined by the detection of variations above a certain threshold. The threshold may be determined using known defects in similar components. Alternatively, simulations may be used to determine appropriate thresholds.

After a defect has been identified, it may be desirable to monitor the defect over time. Therefore, it may be possible to determine the growth rate of the defect and accurately determine when a particular section of pipe needs maintenance or replacement. Alternatively, a region prone to defects such as high stress areas including, but not limited to flanges, curves, and fillets may be monitored as a way to determine the overall health of the pipe over time.

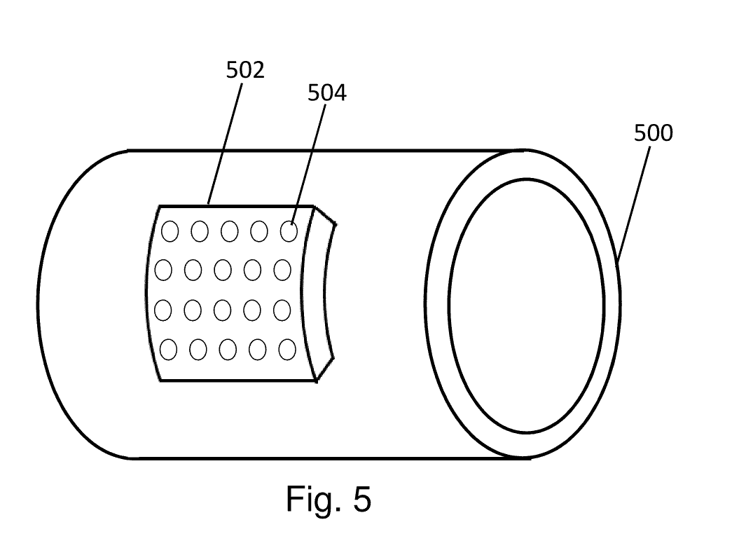

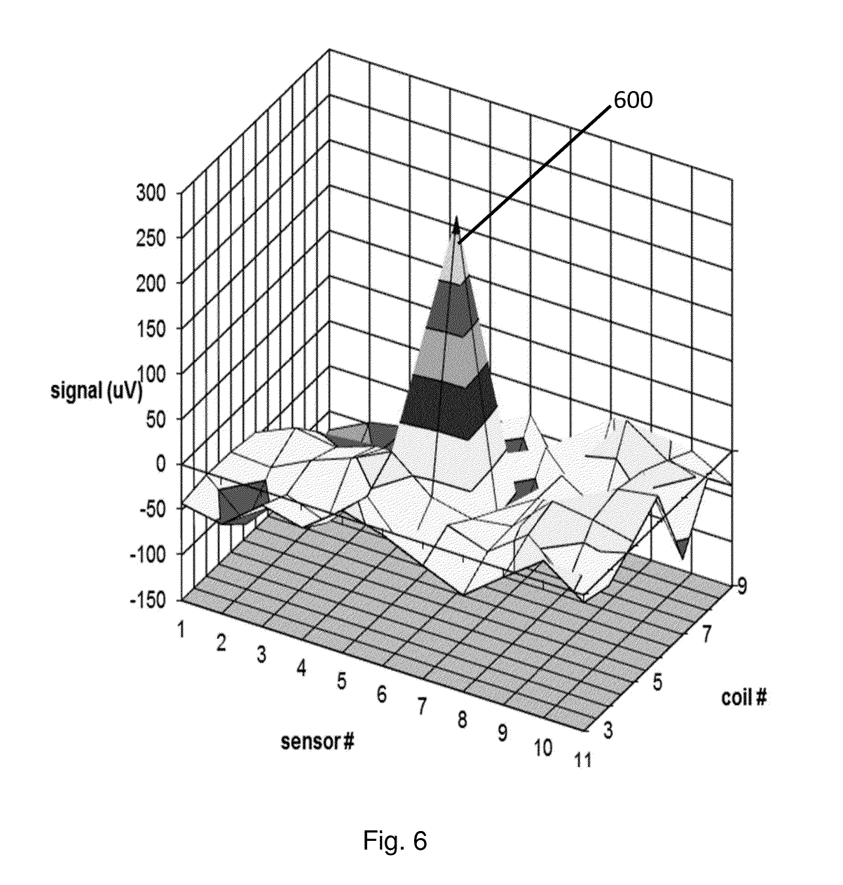

In one embodiment, as shown in FIG. 5, an identified area of interest on a reinforced concrete pipe 500 may be monitored using a flexible sensor array 502 containing a plurality of eddy current sensors 504. The sensor array may be described as somewhat akin to a magnetic field camera, and may produce high resolution magnetic images showing defects such as cracks, corrosion, and thinning in the reinforcing members within the pipe as a function of time. A graph of a magnetic signal from an array of sensors for a defect in a uniform Inconel substrate is presented in FIG. 6. The defect is indicated by peak 600 which is a variation in the detected signal as compared to the background signal of the remaining substrate. While the depicted figure is related to a uniform substrate, the same concept of a variation in the signal would also apply to detecting defects in a metal reinforcement contained within a reinforced concrete pipe. The images can be collected and cataloged in real-time or over a long period of time. Therefore, the images may permit comparisons of the state of a pipe throughout its lifetime.

In some applications, the flexible array could be added to a pipe either while in service or during construction. The sensing sheet could be relatively thin and flexible so that it could be mounted to curved surfaces on either the inside or outside of the pipe using an appropriate adhesive. In some embodiments the array may be approximately 50 μm, 100 μm, 200 μm, 300 μm, 400 μm, 500 μm, 1,000 μm, or any other appropriate thickness that is flexible enough to attach to the intended surface and contain the necessary eddy current sensors. In some embodiments, the array may be made of high durability plastic that is substantially unaffected by gas, water, and/or corroded metal.

In one embodiment, the array may be constructed using a flexible membrane composed of two thin conductive layers with a dielectric layer in between. The coil driver may be made using photolithography on the conductive layers of the flexible membrane which allows the array to be fabricated with extremely high uniformity, excellent registration, and low cost. In some embodiments, each sensor element may include two turns in the driver coil, one coil on the top and one on the bottom of the membrane. If the membrane is thin enough relative to the size of the coils, both coils may contribute to the magnitude of the eddy currents generated in the reinforcing members of the pipe being inspected thus doubling the eddy current intensity as compared to a single turn driver. In addition to the coil drivers, multiple sensing loops may also be formed using photolithographic fabrication. In such an embodiment, the sensing loops may be formed in the same substrate and on the same planes as the coil drivers. Without wishing to be bound by theory, it is believed that a greater number of sense turns may be made in the flexible membrane, as compared to other traditional materials such as a PCB, because the flexible membrane is relatively thin as compared to those traditional materials and thus smaller holes on the order of 30 um in diameter can be laser drilled and plated to form vias (i.e. through holes). Comparatively, a conventional PCB has vias and associated annular rings that are approximately 560 μm in diameter. Thus, the small feature size may enable the production of a sense coil inside of the drive coil that loops multiple times from the bottom to the top of the membrane through the provided vias. In view of the above, the material may enable sensor elements with two drive coils on the top and bottom of the membrane and sense coils with multiple turns from the top to the bottom of the membrane through laser drilled vias. In some embodiments, the number of turns of the sense coils may be 5 to 10, 10 to 20, or any other desired, and physically possible, number given the possible via size, driver coil size needed for the desired application, and other relevant considerations. The size of the array, size of the sensor elements, and the density of sensor packing (for spatial resolution) may be altered for the particular sensing application. In some instances it may be desirable to construct larger sensors that have a greater penetration depth and/or sensing area. In other instances it may be desirable to construct smaller sensors that are capable of detecting smaller defects.

Without wishing to be bound by theory, the above noted lithographic processing techniques lend themselves to patterning either very small arrays or possibly very large arrays. The size of the arrays would only be limited by the abilities of the materials and processing techniques themselves. Therefore, depending on the size of the defect, or component, being monitored the size of the array may be easily varied. In some embodiments the array may be between approximately 1 cm² to 10 cm². In other embodiments the array may be between 500 cm² to 1000 cm². The number of sensing elements in the array may also be varied according to the desired application as noted above within the processing limits of the material and techniques used.

The array may be coupled to control electronics that monitor and control the array. The control electronics may include a multiplexer for connection with the multiple sensors, a power source, a power storage, a power controller, a central processor, memory, and a transmission module for communicating the sensor data to a central command system and receiving commands from the central command system. In some embodiments, the control electronics may be sufficiently small so that they may be mounted to the sensor array substrate to make an integrated unit. While certain components have been listed above, the current disclosure is not limited in this way and any appropriate control circuitry for use with eddy current sensors as would be known to one of skill in the art may be used.

In some embodiments it may be desirable to enable the transmission module to communicate with a central command system that is located remotely from the sensor array. In one instance the transmission module may include a transmitter capable of remotely communicating with the central command system directly. In other instances, to lessen the required operation power and component size, it may be desirable to communicate indirectly with the central command system. Therefore in some embodiments, each sensor array may act as a repeater to communicate signals from a first adjacent sensor array to a second adjacent sensor array. If a continuous network of sensor arrays is provided, long distance communications with the central command system may be enabled with minimal power consumption by any single sensor array. In another embodiment, the transmission module may communicate with existing infrastructure to send data to a wired or wireless network for long range data transfer to the central command system.

To enable control and on demand monitoring of specific sensor arrays within a network of multiple sensor arrays, it may be desirable to include a specific identifier with each sensor array. In one embodiment, each sensor array may have an individual identification number (ID). In such an instance, a command from the central command system may contain, for example, a header containing the ID which may be sent prior to a command such as a polling message to broadcast the sensor signals and/or any analyzed data. This would allow only the sensor array corresponding to the specific ID to execute the broadcast commands. Similarly, broadcasts from a sensor array may also include the ID so that the central command system can identify which sensor array is associated with which received broadcast. Depending on the application, each sensor array's ID may either be a preset ID determined during manufacture, or it may be set by the central command system during initial installation and setup.

To provide a sensor array that needs minimal supporting infrastructure and maintenance, it may be desirable to provide an energy harvesting capability for the sensor array. Depending on the particular environment in which the sensor array is located, energy may be harvested using: solar cells, piezoelectric crystals to harvest energy from vibrations of the pipe; flow based generators that harvest energy from a fluid or gas flow; thermoelectric generators that harvest energy from temperature differentials; and any other appropriate energy harvesting device as would be apparent to one of ordinary skill in the art. The energy harvesting device may be selected and sized appropriately to provide the power needed for the specific sensor array given the local conditions in which it will be installed.

In addition to providing energy harvesting capabilities, the control electronics may also limit energy consumption to minimize the needed power. To minimize power usage the control electronics may only operate the sensor array and/or transmission module at predetermined intervals and/or upon request from the central command system. When not actively operating the sensor array and/or transmission module the sensor array may operate in a passive receiving mode where it may receive commands from the central command system while the rest of the sensor array is unpowered.

While the above embodiments have depicted combined sensors and drivers, the current disclosure is not limited to using only combined sensors and drivers. For example, one or more separate drivers and one or more sensors may be used to detect defects in an underlying structure as described in more detail below.

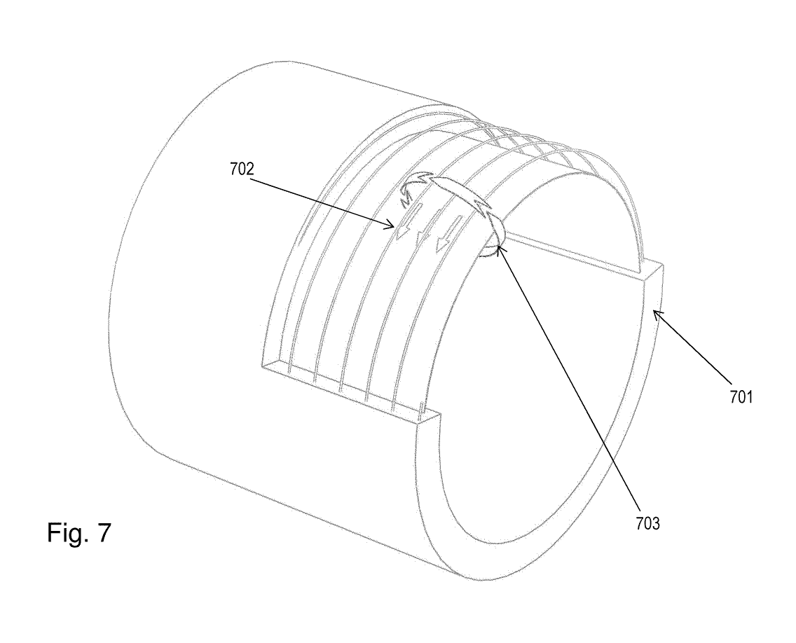

In one possible embodiment, a drive coil creates a magnetic field to create eddy currents in the reinforcement wires of a pre-stressed concrete core pipe. The produced eddy currents create a corresponding magnetic field which can be measured to provide information about defects present in the reinforcement wires as described above. While it may be desirable to maximize the energy coupling to the system under test, it may also be desirable for the drive coil to have minimal cross-talk with the sensor. A schematic illustration of testing of a pre-stressed concrete core pipe is depicted in FIG. 7. In the depicted embodiment, a drive coil, not depicted, is located within the reinforced concrete pipe 701 and creates circumferentially oriented eddy currents 702. Without wishing to be bound by theory, to provide circumferentially oriented eddy currents the drive coil's varying magnetic field 703 should be substantially oriented such that it circles around the desired eddy currents.

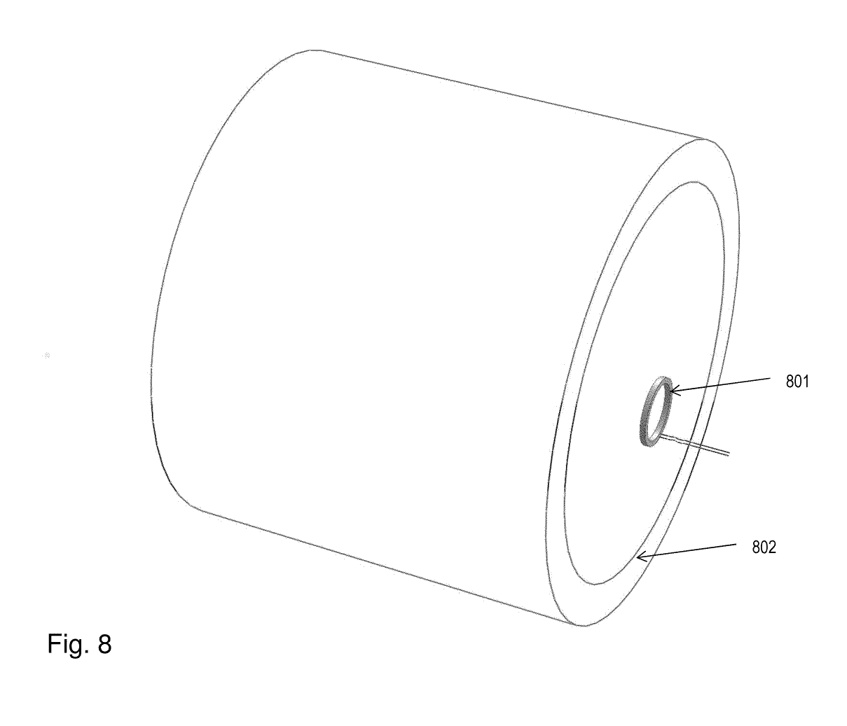

One possible way in which to create the magnetic fields depicted in FIG. 7, is to provide a magnetic coil 801 located and oriented within the pipe 802 as depicted in FIG. 8. In the depicted embodiment, the coil's axis is substantially parallel to the pipe 802 and may be located near the wall of the pipe 802. Once appropriately positioned, an electric signal is applied to excite coil 801. Without wishing to be bound by theory, one possible drawback of such a driver is the potential for cross talk interference with the sensor due to the long range of the coil magnetic field. Therefore in some embodiments, to retain, or enhance, the ability to create circumferential eddy currents in the pipe while greatly reducing the cross talk interference with the sensor, quadrupole coils or higher pole number coils can be utilized.

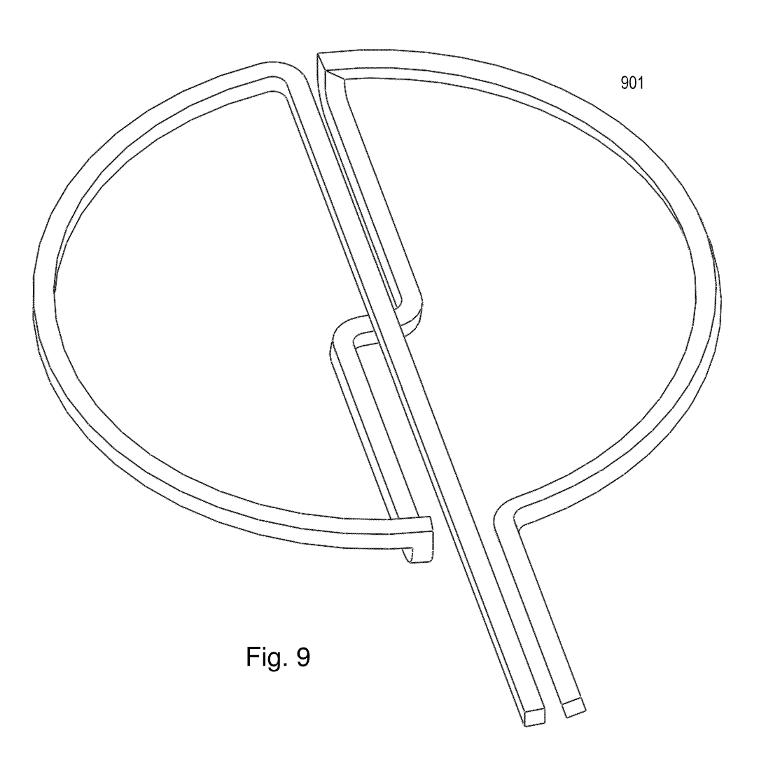

FIG. 9 illustrates one embodiment of a quadrupole coil 901 wound in the shape of a “flattened FIG. 8”. Although the illustration shows only one turn, the actual coil may contain any number of turns to increase the field strength.

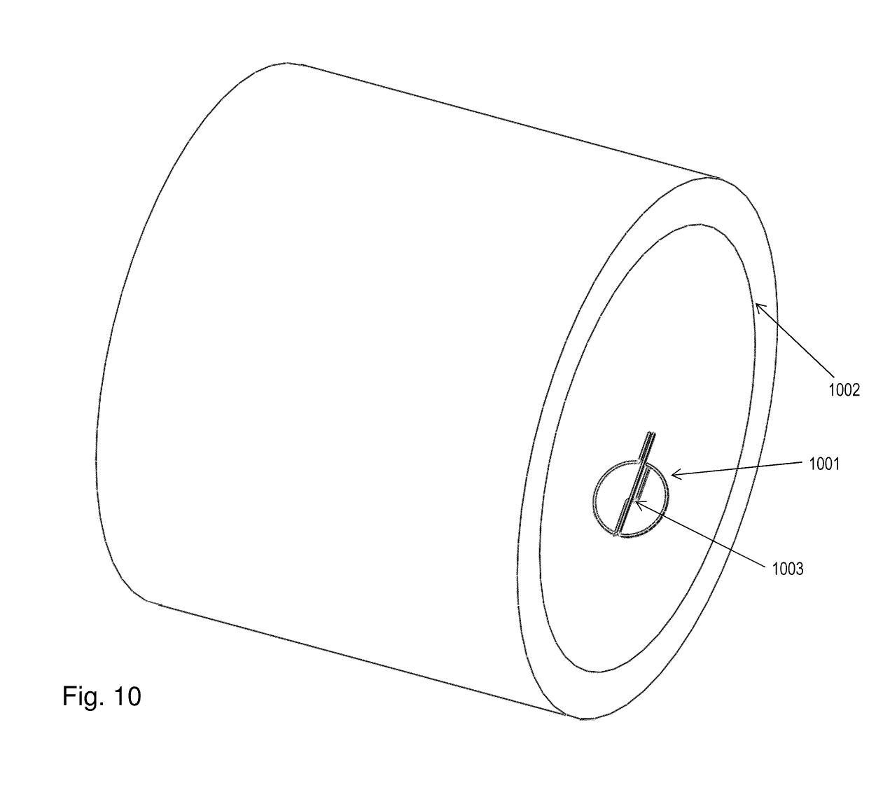

FIG. 10 depicts the coil of FIG. 9, quadrupole coil 1001, oriented within the pipe 1002. As depicted in the figure, the axis of the quadrupole coil 1001 is oriented in a substantially radial direction of the pipe. Further, the “central conductors” 1003 of the coil 1001 are oriented in a the direction that is substantially tangential to the circumference of the pipe. Without wishing to be bound by theory, by making the radius of the coil sufficiently large, the magnetic field near the coil area (i.e., where the eddy currents are large) may look similar to the magnetic field created by a simple coil as depicted in FIGS. 7-8. At a distance from the quadrupole coil the cross talk magnetic field is much weaker than that of a simple coil. Therefore, this effect may reduce the level of cross talk with sensors located at a distance from the quadruple coil as compared to sensors associated with a simple coil at the same distance.

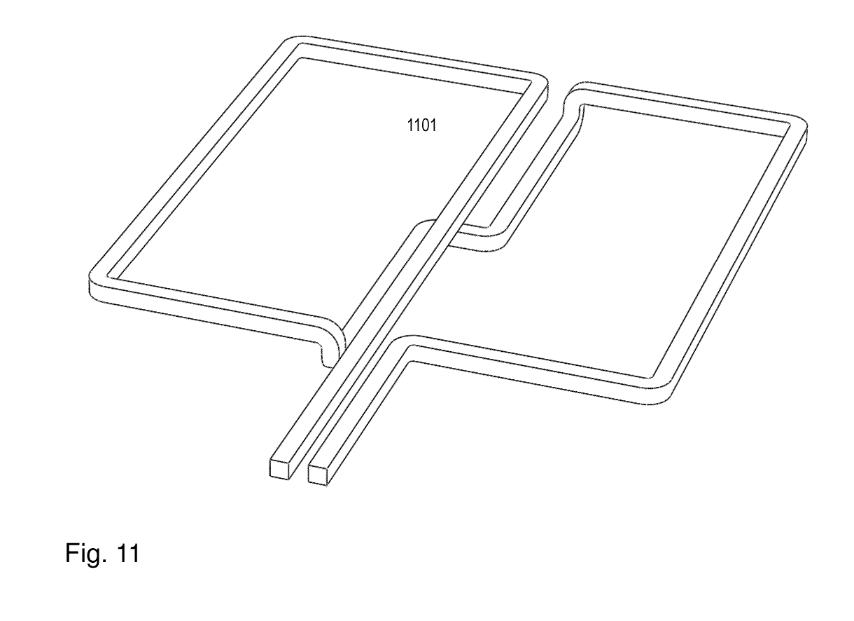

While a specific embodiment of a quadrupole coil has been depicted above, various other embodiments of a quadrupole and higher n-pole current drivers can be built which will both further enhance the magnetic field in the desired eddy current area and further weaken the cross-talk with the sensor. One such example is shown in FIG. 11 which depicts a squared off version of a quadrupole coil 1101.

For pre-stressed concrete core pipe inspection, the separation between the drive coil and the metal to be inspected is dictated by the thick concrete liner, which may be about 5 cm to 20 cm thick depending on the size of the pipe. This means that the drive coils have to be large, and in some embodiments may have diameters between about 10 to 100 cm. This is in comparison to drive coil diameters less than about 1 cm in more typical eddy current inspection systems. Both the resistance and the power dissipated in the coil increases linearly with coil size. Therefore, larger coils require greater amounts of power. Further, the long length of the pipes to be inspected make it desirable to use battery power for the system, but power dissipation in the drive coil limits the battery life. Consequently, while the above embodiments have disclosed generating eddy currents in a desired structure by passing electrical current through a coil, meander line, or other conducting path, other methods of inducing an eddy current in a structure are also envisioned. For example, in some embodiments, and as described in more detail below, an eddy current may be produced by mechanically rotating a permanent magnet.

Without wishing to be bound by theory, the purpose of a drive coil is to generate a time varying magnetic field. However, as noted above, the field may also be generated by the mechanical rotation of a permanent magnet. The frequency used when inspecting pre-stressed concrete core pipe is low compared with many electrical capacitance tomography measurements, which makes it compatible with mechanical rotation of macroscopic objects like a magnet, though such an embodiment may also be used for applications other than inspecting pipes as would be apparent to one of skill in the art.

Without wishing to be bound by theory, drive coils formed by a current loop create a magnetic dipole with a moment, μ=NiS, where N is the number of turns, i is the current, and S is the surface area of the loop. In comparison, a permanent magnet is also a magnetic dipole, with moment μ=2*Br*S*1/μ₀, where Br is the field generated by the magnet (the strength of the magnet), 1 is the separation of the poles (the effective length of the magnet), S is the surface area of the poles, and μ₀ is the permeability of air. Modern rare earth magnets may generate magnetic fields in excess of 1 Tesla. Assuming a 1 Tesla field strength and a 25 cm length and 2 cm diameter, the magnet would have a magnetic moment of about 12.5 Amp·m². In comparison, a similarly sized coil would require 2500 A-turns (ampere turns) to generate the same magnetic moment. Thus permanent magnets compare very favorably to current loops in terms of the size of the field generated. In addition the permanent magnet may have higher uniformity and lower noise as compared to coils. It should be understood that magnets with different field strengths and dimensions may also be used.

Without wishing to be bound by theory, the frequency range associated with measurements of pre-stressed concrete core pipe measurements, as well as other possible measurements, are compatible with mechanical motion. More specifically, the frequencies at which pipe inspections are made range from as low as 30 Hz to about 300 Hz, which corresponds to about 1800 to 18000 revolutions/minute (rpm). The embodiment of a permanent magnet described above has a mass of approximately 600 g and a moment of inertia of 3000 g·cm2. This is not a mechanically extreme situation (e.g., lightweight automobile flywheels may have as much as 20× the moment of inertia of the magnet and may be designed to rotate at up to 6000 rpm or more, depending on the engine). Due to the small load, even the high end of the frequency range may be achievable with high quality bearings. Therefore, from a mechanical standpoint, it is reasonable to consider replacing the drive coil of the inspection system with a mechanically rotating permanent magnet. Further, once the magnet is rotating the system will not require significant power since the earth's magnetic field is weak and the loading due to the eddy currents is miniscule, so the motor only needs to compensate for the losses in the bearings.

In some embodiments, the frequency of the rotating magnet may be less than or equal to about 1 kHz, 900 Hz, 800 Hz, 700 Hz, 600 Hz, 500 Hz, 400 Hz, 300 Hz, 200 Hz, 100 Hz, 50 Hz, 10 Hz, or any other appropriate frequency. The above maximum frequencies may be combined with frequencies that are greater than or equal to about 1 Hz, 10 Hz, 50 Hz, 100 Hz, 200 Hz, 300 Hz, 400 Hz, 500 Hz, or any other appropriate frequency. The above frequency ranges may be combined (e.g. the rotating magnet may have a frequency between about 30 Hz and 300 Hz). Other combinations are also possible.

In some embodiments it may be desirable to use a motion other than pure rotation of the magnet, for example mechanical angular oscillation back and forth about an axis, translational oscillation, or vibration of the magnet may be used. Further, in some embodiments, the rotation or vibration of the magnet may be provided by an electric motor. However, without wishing to be bound by theory, electric motors may themselves produce a strong magnetic signature at the frequency of operation and with an arbitrary phase. This signal may be picked up by the sensors and may contribute to signal noise, making it difficult to distinguish the signal due to the eddy currents near the defect. To avoid this situation it may be desirable to place the motor at some distance from the magnet and drive the magnet with a mechanical linkage. In this case it may be possible to place magnetic shielding between the motor and the sensor. Alternately, it may be desirable to drive the motor at one frequency, and to use mechanical gears so that the magnet rotation and measurements are made at a different frequency.

Without wishing to be bound by theory, the eddy currents generated by the moving magnet will create a secondary magnetic field. Any defect that changes the path, amplitude, or phase of the eddy currents will have an associated change in the secondary magnetic field. The defect can thus be detected by magnetic sensors that are appropriately placed to respond differently to the unperturbed magnetic field and to the field modified by the perturbation. For example, the sensor may be placed in a location where a particular direction component of the magnetic field is zero in the absence of a defect but is non-zero when a defect is present. Conversely, the sensor may be placed in a location where the magnetic field is non-zero in the absence of a defect (for example due to transformer coupling in remote field eddy current) but is zero when a defect is present.

The sensor used in the above embodiments can be any suitable magnetic sensor, such as solid state sensors including anisotropic magnetoresistive (AMR) sensors, giant magnetoresistive (GMR) sensors, magnetostrictive sensors, or any other solid state magnetic field sensors, or may be solenoid sensors such as wound wire coil or a photolithographically fabricated coil, and may be single sensors or sensor arrays. Sensors that have specific directional sensitivity, including but not limited to AMR sensors may be used in certain embodiments. Without wishing to be bound by theory, providing sensors with directional sensitivity, for example as obtained with AMR sensors, may be particularly desirable for use with a rotating magnet used to generate the field, since the rotating magnet is equivalent to two orthogonal oscillating magnetic moments which will generate a more complicated geometric distribution of magnetic fields than does a current loop. As compared to coil sensors, AMR sensors are sensitive to field rather than the rate of change of flux and may be physically small relative to the size of the pipe. Therefore, in some embodiments, it may be practical to consider using an array of sensors to optimize the POD of defects.

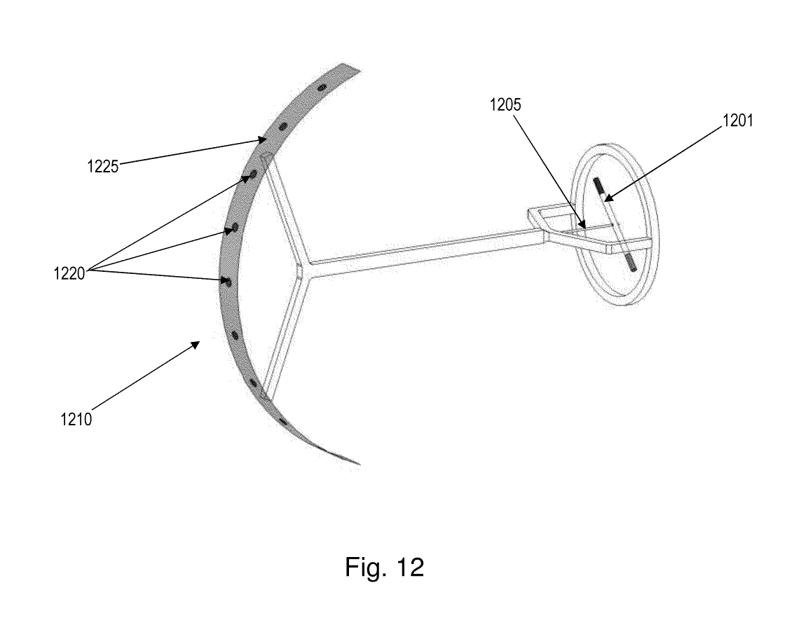

Any number of different sensor array arrangements might be used with the disclosed embodiments. Two possible embodiments of the sensor array arrangements coupled with a rotating permanent magnet are described in more detail below in FIGS. 12-14 regarding stressed concrete core pipe inspections. For example, in one embodiment, it may be desirable to separate the sensors from the generator to avoid direct coupling. In such an embodiment, it may be desirable to use an array mounted at the opposite end of a diameter from our eddy current generator as in FIG. 12. In this embodiment a rotating permanent magnet 1201 is positioned near the wall of the pre-stressed concrete core pipe, with its rotation axis 1205 aligned with the pipe diameter. A detector 1210 is then positioned near the opposite wall of the pipe at the opposite end of the same pipe diameter. In the depicted embodiment, the detector consists of solid state sensors 1220 on a curved rigid substrate 1225 that extends partially around the inner circumference of the corresponding pipe, but different detectors may be utilized in the same configuration. This is similar to the geometry utilized in P-wave inspection.

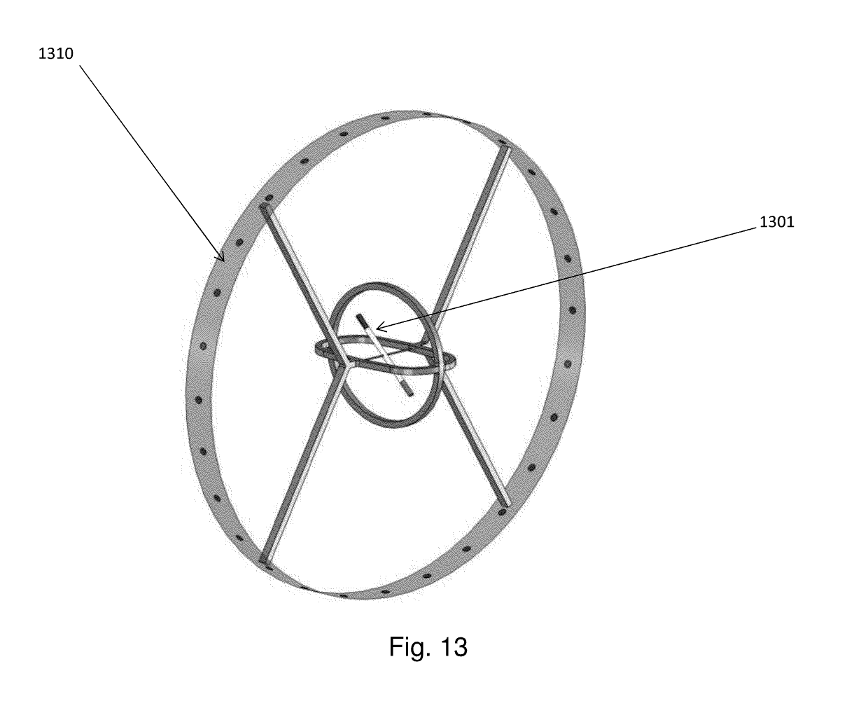

In other embodiments, direct coupling may be avoided through the choice of orientation of the sensors which may enable a more symmetric orientation as shown in FIG. 13. In this embodiment the magnet 1301 is positioned at the center of the pipe and a circular array of sensors 1310 may be positioned around the interior perimeter of the pipe. In such an embodiment, a multiplexed sensor readout might permit the circumferential location of a detected defect to be determined.

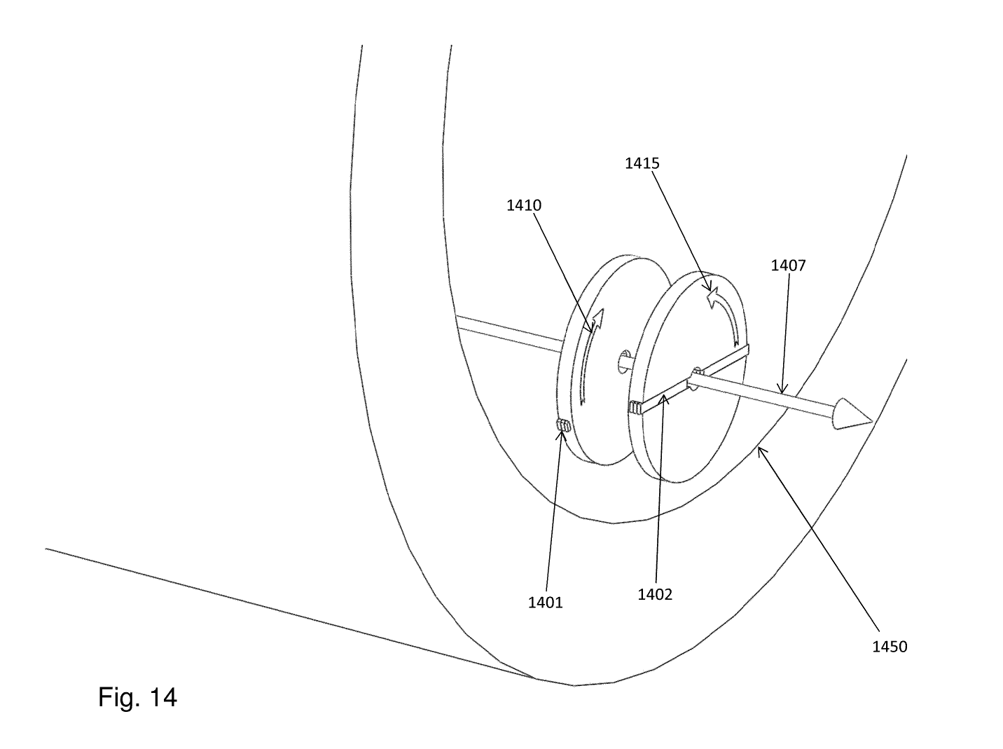

Without wishing to be bound by theory, a drive coil creates a sinusoidal time varying magnetic moment along one direction, parallel to the axis of the loop. In contrast, a rotating magnet, creates a time varying magnetic moment along two orthogonal axes in the plane of the motion. While this may influence the distribution of the eddy currents, it is not anticipated that the magnetic moment along the second axis would interfere with the ability of the system to detect cracks. However, in some embodiments, the above situation may be addressed as shown in FIG. 14 by using two magnets 1401 and 1402 mounted on the same axis 1407 and rotating in opposite directions 1410 and 1415 about the axis. In the depicted embodiment, the rotation axis 1407 is substantially parallel to the axis of the pipe and the rotation phase is chosen to create a maximum magnetic field in a radial direction, normal to the pipe wall 1450. The magnetic moment of the two magnets may add along one axis and cancel along the orthogonal axis, so that the resulting magnetic field may more closely match a field generated by a coil. In such an embodiment, the mechanical design may include gears to make sure that the counter rotation is within preselected operating parameters. In addition, at low angular speeds the attraction and repulsion of the magnets may place a significant load on the rotation motor, so in some embodiments it may be necessary to utilize an armature to keep the magnets apart when they are not moving and slowly bring them closer as the rotation rate increases.

Embodiments using drive coils may use the coil current phase as a reference for detecting and analyzing the detected signal to obtain information from separating the in-phase and quadrature (90° out of phase) components of the detected signal. However, in the case of mechanical rotation of a magnet, there may an arbitrary phase shift between the motor drive signal and the rotation of the magnet, so that the reference provided by the motor drive signal may not be reliable. Further, in some embodiments, as described above, gears may be used to convert the drive frequency to a rotation frequency that is not a harmonic of the drive frequency, in which case the drive signal cannot serve as a reference signal at all. Therefore, in the above embodiments, it may be necessary to use an encoder, such as an optical encoder, to generate a reference signal for phase-locked detection of the sensor output signal.

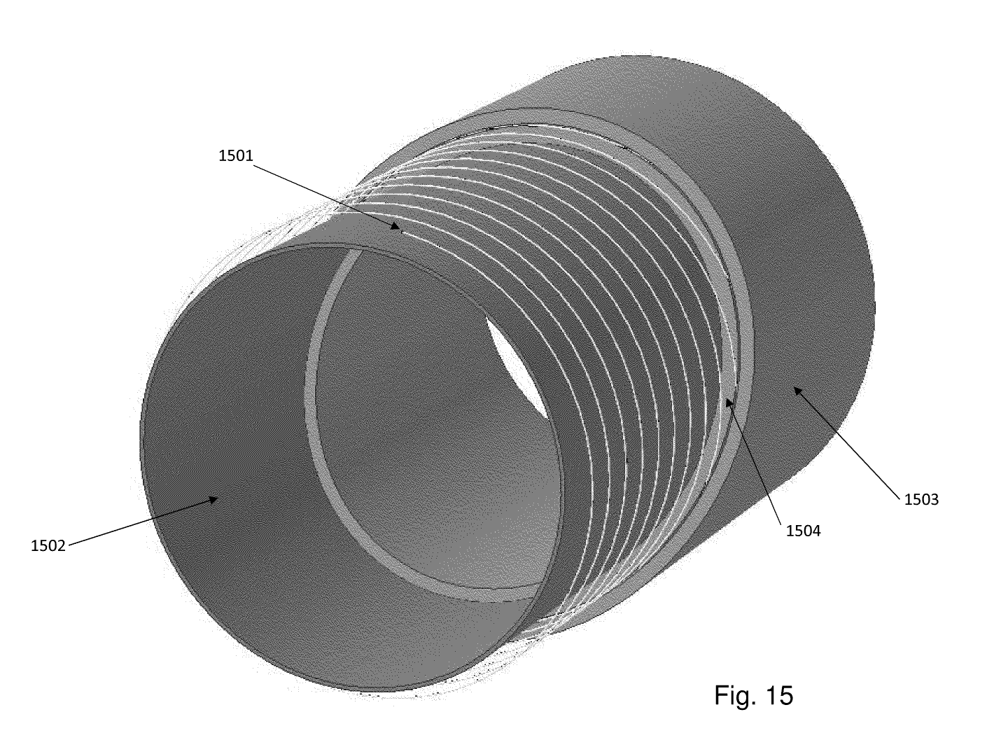

Without wishing to be bound by theory, in order to better understand how a driver may interact with a structure, and how to best maximize the detection signal, it may be helpful to look at the construction of the structure being probed. One embodiment of the structure of a pre-stressed concrete core pipe is shown in FIG. 15. The depicted pre-stressed concrete core pipe includes a helically wound steel tension wire 1501 around a steel cylinder 1502 with concrete encasement 1503 around and an area in-between the cylinder and wire. The depicted embodiment corresponds to embedded cylinder pre-stressed concrete core pipe which is formed by filling the area 1504 in-between the winding and the cylinder core with concrete before the tension wire 1501 is wrapped around the core.

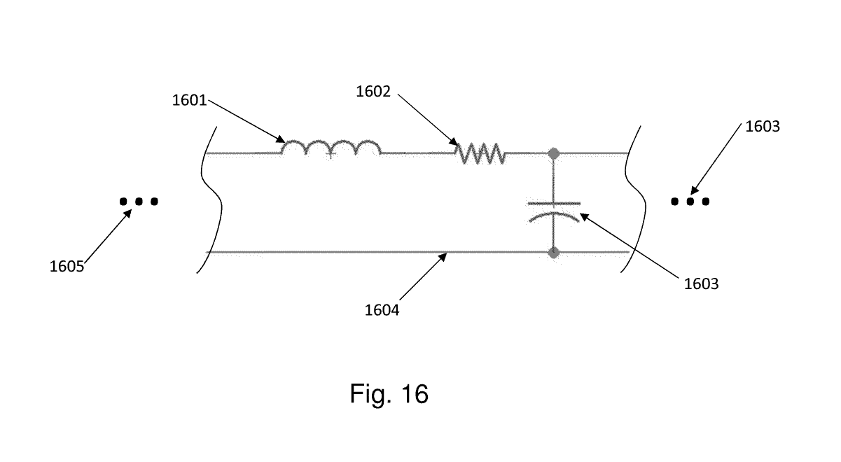

The structure depicted in FIG. 15 may be modeled as a simplified electrical circuit (FIG. 16) that is distributed along the length of the pipe. This model is a distributed L-R-C circuit where the coil of tension wires is represented by the inductance 1601, the resistivity of the steel wire is represented by the resistance 1602, and the separation of the wire and cylinder with concrete in between is represented by the capacitance 1603. The pipe is represented by the ground node 1604. Since the circuit is distributed, the values represent per-unit lengths of pipe. For instance, if the resistance of the wire is 5Ω over the entire length of a 12 ft. pipe, then the distributed resistance is 5 Ω/in.

The circuit can be considered as an element that can be excited by an electromagnetic field generated by a driver. The driver may be any element that generates an electromagnetic signal in the tension wires. For example, the driver may be a voltage applied to the wires by physical contact with a drive circuit, for example using clip-leads or any other means known in the art. Typically, however, the tension wires will be embedded in concrete and the pre-stressed concrete core pipe may be buried in the ground. In that case, direct electrical contact to the wires may not be practical. In those cases, indirect coupling may be achieved by generating an oscillating electromagnetic field in the vicinity of the wires by any convenient method such as wound wire coil or a rotating magnet as described above.

Without wishing to be bound by theory, the pipe structure can be more effectively excited by choosing an alternating electromagnetic field frequency that substantially matches the electromagnetic resonance of the pipe structure. An L-R-C circuit has a natural frequency, ω of

$$\frac{1}{\sqrt{LC}}$$

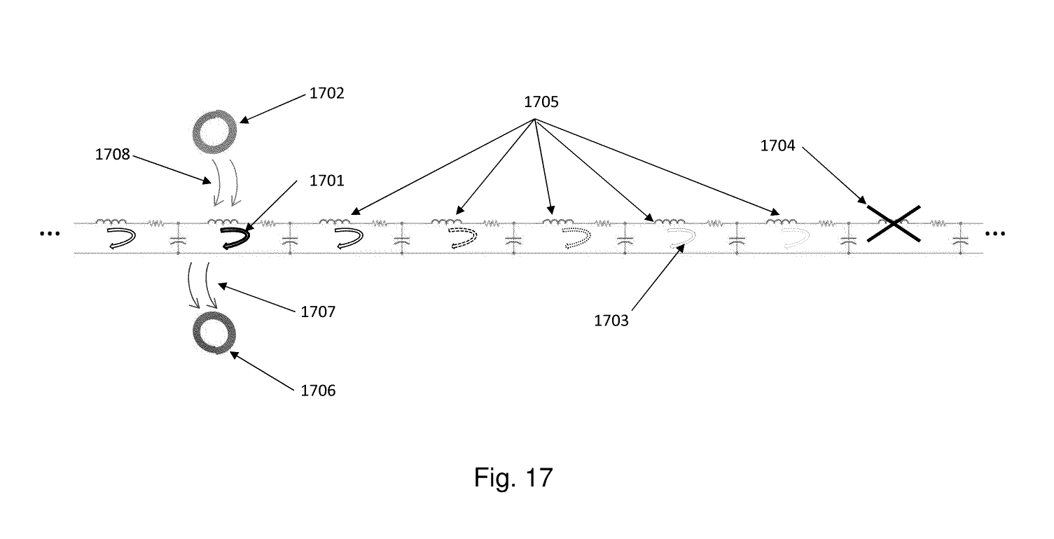

rad/s. The quality of the resonance, and therefore the effectiveness of using the electrical resonance of the pipe circuit is affected by the series resistance 1602. A higher resistance results in more damping in the circuit and less effective excitation, where a lower resistance is the opposite but has a narrower frequency band. Because of these losses, the length of pipe that becomes excited due to a driver located in a specific place (see FIGS. 17 & 18) is limited along the pipe. For example, the signal in the distributed elements near 1701 to the driver 1702 are stronger than the signal in the elements further away 1703. For example, a break 1704 in a tension wire winding far away from the driver/detector pair will have less effect on the resonating signal (FIG. 17). In contrast, a break 1804 in a tension wire winding near to the driver/detector pair will have a greater effect on the resonating signal. By scanning the driver/detector through the pipe, the signal will be different in the area of the break. In this way it is possible to discern the location of the defect.

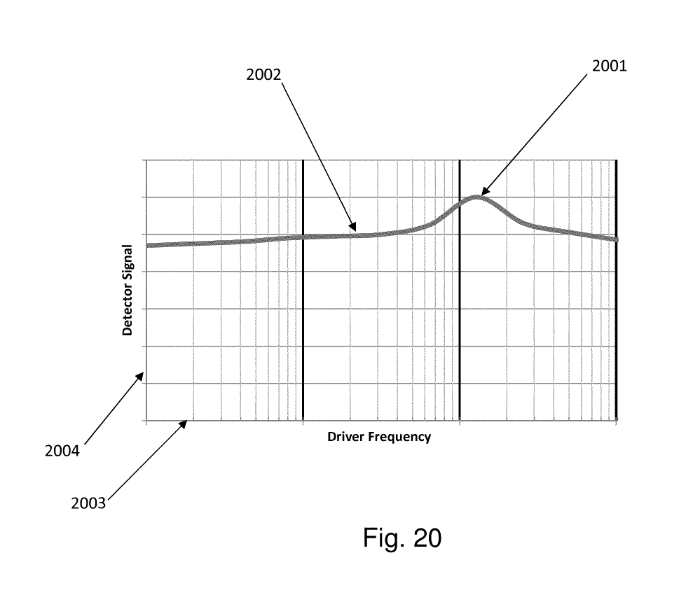

In one embodiment, the driver frequency is determined by calibrating the system relative to the specific structure being probed. In such an embodiment, a driver 1901 and detector 1902 may be appropriately arranged and affixed to the inside of the pre-stressed concrete core pipe, or other appropriate structure, in such a way as to maximize the signal induced in the pipe tension wire windings 1903. The detector may then be positioned to maximize the pickup of the induced signal in the wire and minimize the direct coupled signal 1904 from the driver. This embodiment may also include a shield 1905 to further reduce direct coupling between the driver and detector. Generally, the driver/detector pair may be positioned in the center of an unbroken section of pipe (e.g. where the wire structure is most uniform or intact), for calibration. The frequency of the driver is subsequently swept at constant power, and the signal from the detector is recorded (FIG. 20). The frequency corresponding to the maximum signal 2001 may then be selected as the driving frequency to optimize the detected sensor signal. In some embodiments, this frequency may correspond to the fundamental electrical resonance frequency of the structure or a higher harmonic of the fundamental electrical resonance frequency of the structure.

Having thus described several aspects, it is to be appreciated various alterations, modifications, and improvements will readily occur to those skilled in the art. Such alterations, modifications, and improvements are intended to be part of this disclosure, and are intended to be within the spirit and scope of the aspects of the invention. Accordingly, the foregoing description and drawings are by way of example only.

What is claimed is:

1. A method for detecting defects in reinforced concrete, the method comprising:
providing a probe with a plurality of eddy current sensors disposed along a circumferential direction of the probe;
inducing an eddy current in a reinforcing structure of the reinforced concrete with at least one of the plurality of eddy current sensors; and
detecting a circumferential and longitudinal location of a defect in the reinforcing structure of the reinforced concrete with at least one of the plurality of eddy current sensors.

2. The method of claim 1, wherein each eddy current sensor includes a driver and a sensor.

3. The method of claim 1, wherein the eddy current sensors include a driver comprising a quadrupole coil or a coil with a pole number greater than or equal to 4.

4. The method of claim 1, wherein detecting the defect further comprises detecting a defect in a reinforced concrete pipe.

5. The method of claim 1, wherein inducing the eddy current further comprises inducing an eddy current in a metal rod.

6. The method of claim 5, wherein inducing the eddy current in the metal rod further comprises inducing an eddy current in rebar.

7. The method of claim 1 further comprising analyzing data to identify individual pieces of the reinforcing structure.

8. The method of claim 1 further comprising spinning the probe.

9. A method for detecting defects in reinforced concrete, the method comprising:
providing a flexible array of eddy current sensors disposed along a circumferential direction of the probe;
inducing an eddy current in a reinforcing structure of the reinforced concrete with at least one of the plurality of eddy current sensors; and
detecting a defect in the reinforcing structure of the reinforced concrete with at least one of the plurality of eddy current sensors.

10. The method of claim 9, wherein each eddy current sensor includes a driver and a sensor.

11. The method of claim 9, wherein the eddy current sensors include a driver comprising a quadrupole coil or a coil with a pole number greater than or equal to 4.

12. The method of claim 9 wherein inducing the eddy current further comprises inducing an eddy current in a metal rod.

13. The method of claim 12 wherein inducing the eddy current in the metal rod further comprises inducing an eddy current in rebar.

14. The method of claim 9 further comprising transmitting a signal to a central command system.

15. The method of claim 9 further comprising transmitting a signal to another array.

16. The method of claim 9 further comprising repeating a signal received from another array.

17-19. (canceled)

20. A method for detecting defects, the method comprising:
providing a probe with a plurality of eddy current sensors disposed along a circumferential direction of the probe;
inducing an eddy current in a material with at least one of the plurality of eddy current sensors; and
detecting a circumferential and longitudinal location of a defect in the material.

21-25. (canceled)

26. A method for detecting defects in a structure, the method comprising:
providing a probe with at least one driver and a plurality of eddy current sensors disposed along at least a portion of the periphery of the probe;
inducing an eddy current in the structure with the at least one driver; and
detecting a defect in the structure with at least one of the plurality of eddy current sensors.

27-28. (canceled)

29. A method for detecting defects in a structure, the method comprising:
providing a probe with at least one driver and at least one eddy current sensor; and
inducing an eddy current in the structure with the at least one driver at a frequency that substantially corresponds to an electrical resonance frequency of the structure.

30-31. (canceled)

32. A method for detecting defects in a structure, the method comprising:
providing a probe with at least one driver and at least one eddy current sensor, wherein the driver comprises at least one rotatable permanent magnetic; and
rotating the at least one permanent magnet at a frequency to induce eddy currents in the structure.

33-38. (canceled)
